(19) United States
(12) Patent Application Publication
(10) Pub. No.: US 2026/0366964 A1
(43) Pub. Date: Nov. 19, 2026

(54) TWO STAGE PIPETTING BLOCK CAPABLE OF LOW VOLUME AND HIGH VOLUME RANGES WITH A SINGLE INSTRUMENT

(71) Applicant: Almond Designs, Inc., Walnut, CA (US)

(72) Inventors: Felix Hau Fai YIU, Walnut, CA (US); Xiaoping ZHOU, Arcadia, CA (US)

(21) Appl. No.: 19/679,526

(22) Filed: May 15, 2026

Related U.S. Application Data
(60) Provisional application No. 63/808,067, filed on May 19, 2025.

(51) Int. Cl. G01N 1/14

(52) U.S. Cl. CPC G01N 1/14; G01N 2001/1427

(57) ABSTRACT

A pipette dispensing apparatus with a multistage piston design that provides the capability to perform air displacement pipetting at a wide volume range. The pipettor block provides reliable sealing of the air cushion using a multiple o-ring design combined with machined channels and pistons that have varying diameters through their vertical range. The apparatus allows a single air displacement pipettor to be used for both low volume and high volume dispensing tips.

### CROSS-REFERENCE TO RELATED APPLICATIONS

This application claims the benefit of U.S. Provisional Application No. 63/808,067 filed May 19, 2025, the disclosure of which is incorporated herein by reference in its entirety.

### TECHNICAL FIELD

The present disclosure relates to laboratory equipment, and more particularly to a pipette dispensing block used in science laboratories that aspirates and dispenses fluid volumes in a precise and controlled manner.

### INTRODUCTION

The present disclosure relates to the field of liquid pipetting using the air displacement pipetting technique. Air displacement pipettors can be used to pipette volumes of liquid (also described as to aspirate and dispense liquid), a typical volume range being 1 microliter to 5 milliliters of liquid.

The air displacement pipettor is based on a well-established design that uses a moving piston within a cylinder which may be machined, injection-molded, or similarly constructed. This cylinder is attached to a pipettor tip (tip) which can be submersed into a liquid container. When the piston is withdrawn away from the tip, it creates a partial vacuum (or lower pressure) within the cylinder chamber which will cause the liquid to rise into the tip due to ideal gas laws. This is referred as the aspiration step. The tip can then be moved out of the liquid container, and the liquid will remain within the tip without falling out due to the partial vacuum or lower pressure within the cylinder chamber above the tip. After the aspiration step, the tip can be lifted from the source liquid container and moved to another location such as a destination container while retaining the liquid in the tip. When the tip is in position over the destination container, the piston can then be moved downward toward the tip which will cause an increase in pressure in the air column between the piston and the liquid inside the tip. This increased pressure will then cause the liquid to be dispensed from the tip into the destination container.

A common method for containing the liquid is to use a disposable pipette tip to hold the liquid after it is aspirated and before it is dispensed. A common material used for the pipette tips is polypropylene. The advantage of a disposable pipette tip in comparison to a reusable fixed tip is that the liquid being pipetted only comes into contact with the disposable tip, which is discarded after each use thus preventing any carryover or sample-to-sample contamination in between pipetting operations. Reusable fixed tips must be washed in between each pipetting operation, and even the washing protocol does not guarantee complete elimination of carryover. Therefore, the use of disposable pipette tips is very common in various applications.

Air displacement pipettors can be configured to pipette one liquid sample at a time, or more than one at the same time via parallel operation. When more than one sample is pipetted at the same time, a multichannel pipettor is commonly used. A multichannel pipettor is a laboratory tool used to simultaneously transfer precise volumes of liquid into multiple wells. A multichannel pipettor has one disposable tip loaded for each channel. Multichannel pipettors can have a range of channel numbers, typical examples being from 8 tips, 96 tips and up to 384 in arrays of 1x8, 8x12, and 16x24 respectively, being used in parallel.

Typical operational requirements of air displacement liquid pipetting are to achieve defined specifications for accuracy and precision of repeated liquid handling operations. Whether a single channel or multichannel pipettor is used, it is necessary to use an implementation that is designed to be optimized for performance at the user’s desired volume range, otherwise precision and accuracy performance may be suboptimal. For example, attempting to use a pipettor with a cylinder designed for up to 5 milliliters for a 5 microliter operation will result in poor performance at that 5 microliter range. Similarly, a pipettor designed to operation in the 5 or 10 microliter range is not suitable for working with milliliter ranges.

For the reasons described above, it is common in the industry for suppliers to offer their air displacement pipettor products in multiple configurations intended to be used with a variety of different volume ranges. A typical example would be to offer typical single channel air displacement pipettors in multiple sizes such as 4 models with ranges of 0.1-2.5 ul, 2-20 ul, 20-200ul, and 100-1,000 ul. The more advanced and powerful automated multichannel air displacement systems are also offered in similar configurations, such as 5 systems with ranges of 0.5-12.5 ul, 2-50 ul, 5-125 ul, 10-300 ul. and 50-1250 ul.

The current art for air displacement pipettors addresses the needs to perform at a wide range of target volumes while maintaining optimal accuracy and precision performance. However, a drawback of the current art is that the user is required to purchase and maintain multiple pipettors if their ongoing requirements are for wide volume ranges. This requires extra capital expenditure, extra maintenance expenditure, and extra space requirements and inventory management in the laboratory. Pipettor users have expressed a desire for a single pipettor solution that will operate at a wide volume range while maintaining optimal accuracy and precision performance and reducing the overhead required by the current solution of maintaining a collection of pipettors.

### BRIEF SUMMARY

A mechanical design that adapts to varying air displacement pipetting device which may have one or more (e.g., up to 96) individual pipetting channels that will operate with a wide volume range while maintaining optimal performance for both low volumes and high volumes.

One aspect of the disclosure provides A pipetting apparatus including: a pipettor block having at least one channel with a varying internal diameter along a longitudinal axis of the at least one channel; a piston configured to move within the at least one channel and including at least two portions of different diameters; and a sealing arrangement configured to form a seal with a selected portion of the piston based on a position of the piston in the at least one channel.

In one aspect of the disclosure, the sealing arrangement includes at least two o-rings disposed at vertically separated positions along the channel with respective different diameters at the vertically separated positions.

In one aspect of the disclosure, wherein the at least two portions of the piston include a first piston segment with a first diameter and a second piston segment with a second diameter that is larger than the first diameter.

In one aspect of the disclosure, the first piston segment is configured to form a first seal of the sealing arrangement, and the second piston segment is configured to form a second seal of the sealing arrangement, the first seal and the second seal corresponding to different internal diameters of the at least one channel.

In one aspect of the disclosure, the piston remains sealed against the at least one channel during operation using only one of the first seal and the second seal.

In one aspect of the disclosure, the at least two portions of the piston include a first piston segment with a first diameter, a second piston segment with a second diameter, and a third piston segment between the first piston segment and the second piston segment, and the second piston segment has a diameter that is larger than the first diameter and smaller than the third diameter, and the second piston segment forms no seal with the at least one channel during operation of the pipetting apparatus.

In one aspect of the disclosure, when the first piston segment is in use for sealing the at least one channel, the same vertical movement of the piston provides finer volume control than when the third piston segment is in use for sealing the at least one channel.

In one aspect of the disclosure, the at least one channel includes a plurality of channels arranged in an array.

In one aspect of the disclosure, a movement of the piston within the at least one channel enables displacement of air to aspirate and dispense liquid volumes across a plurality of volume ranges including a first volume range corresponding to a first diameter of the at least one channel and a second volume range corresponding to a second diameter of the at least one channel.

One aspect of the disclosure provides a method for pipetting fluid, including: inserting a piston into a channel including at least two regions with respective different internal diameters, the including a first piston region with a first piston diameter and a second piston region with a second piston diameter that is different from the first piston diameter;

selectively forming a seal between the first piston region or the second piston region with the channel based on a position of the piston in the channel; and displacing a fluid using the piston to aspirate and dispense fluid by moving the piston to different regions of the channel.

In one aspect of the disclosure, the selectively forming the seal includes: forming a first seal between the first piston region and a first region of the channel for a first volume range; and forming a second seal between the second piston region and a second region of the channel for a second volume range.

In one aspect of the disclosure, wherein the selectively forming the seal includes: compressing a first o-ring between the first piston region and a first region of the channel for a first volume range; and compressing a second o-ring between the second piston region and a second region of the channel for a second volume range.

One aspect of the disclosure provides a pipetting apparatus including: means for defining a channel with a varying internal diameter along a longitudinal axis of the channel; means for displacing air within the channel via a piston that includes at least two portions of different diameters; and means for sealing a selected portion of the at least two portions of the piston based on a sealing position in the channel.

In one aspect of the disclosure, the means for sealing includes at least two sealing means positioned at distinct vertical locations of the channel.

In one aspect of the disclosure, the pipetting apparatus further includes means for attaching disposable pipette tips to a lower end of the channel.

### BRIEF DESCRIPTION OF THE DRAWINGS

FIG. 1 is a perspective sectional view illustrating a pipettor block and the individual pistons in their respective cylinder channels according to some aspects of the disclosure.

FIG. 2 is a sectional side view illustrating the pipettor block of FIG. 1 and the individual pistons in their respective channels and sealing o-rings according to some aspects of the disclosure.

FIG. 3 is a perspective view of a single isolated piston according to some aspects of the disclosure.

FIG. 4 is a sectional side view of a prior art pipettor block illustrating a pipettor block and individual pistons in their respective cylinder channels.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the present disclosure will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, computer software, firmware, or any combination thereof. Whether such elements are implemented as hardware or software depends upon the particular application and design constraints imposed on the overall system.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements.

In the following discussion that addresses a number of embodiments and applications of the present disclosure, reference is made to the accompanying drawings that form a part hereof, and in which is shown by way of illustration specific embodiments in which the invention may be practiced. The present disclosure may, however, be embodied in other forms and should not be construed as limited to the embodiments set forth herein. Instead, these embodiments are provided by way of illustration only and so that this disclosure will be thorough, complete and will fully convey the full scope of the present disclosure to those skilled in the art.

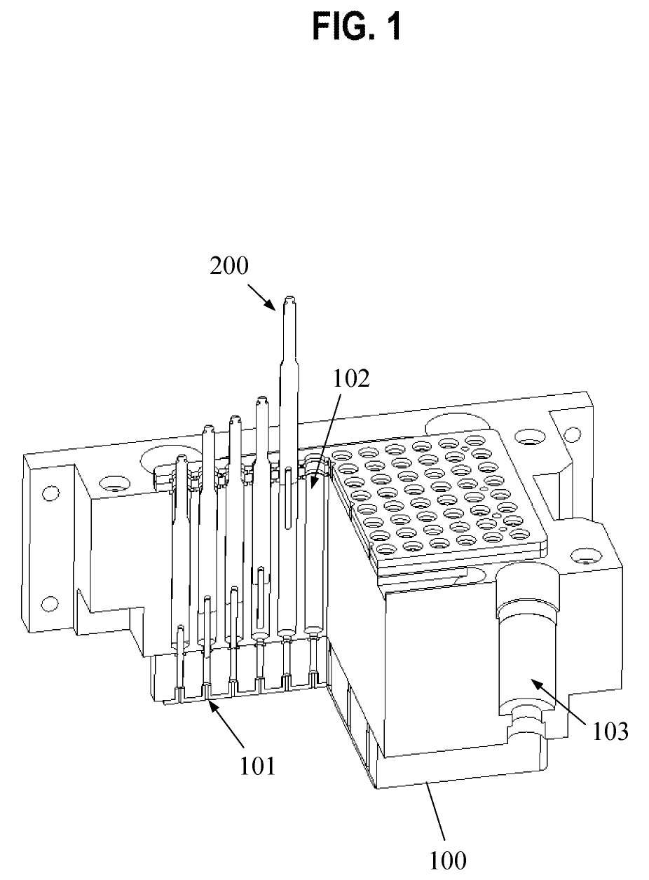

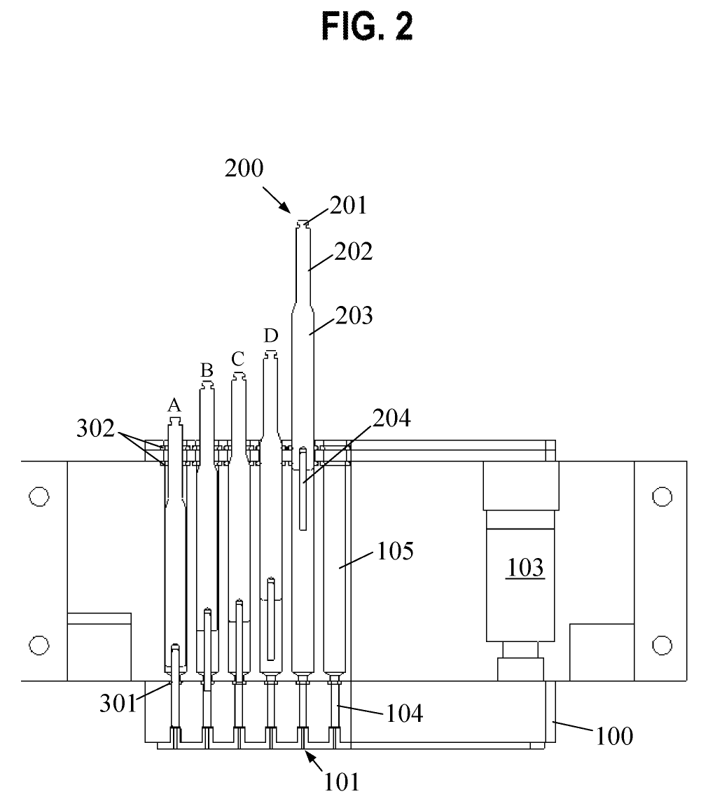

FIG. 1 represents the exterior and interior form of a pipettor block 100 which can be machined with a series of cylindrical channels 102. There are means of mounting 103 the pipettor block 100 to the automated pipettor (not shown) which do not affect the performance of the present disclosure. There are connecting parts 101 (also known as bullets or cones) at the bottom of each channel 102 which allow the attachment of the pipettor tips for air displacement pipetting. These bullets may be of any suitable design to function with various pipette tips without affecting the performance of the embodiment. The pipettor block 100 can be constructed in the typical standardized size format for working with up to 96 samples (or tips). The pipettor block 100 may be constructed of metal or other materials and may be machined, molded, or constructed in other ways. The pipettor block 100 can be a machined or molded top containing 96 separate internal cylindrical channels 102, which are arranged in the typical standardized arrangement of 12 columns and 8 rows. In this example, one row of 12 cylinders is shown and the rest are not shown for clarity. Also shown in FIG. 1 are the pistons 200 which can move slidingly within the individual channels 102 in order to perform air displacement pipetting. In this example, five pistons 200 are shown in five of the twelve channels for clarity, each in a different vertical orientation within and/or above the channels 102. This illustrates how the pistons 200 are able to move up and down within the pipettor block 100 cylindrical channels 102. The pistons 200 each have an attachment fixture 201 (see FIG. 2) at the top which is used to connect to the pipettor drive mechanism that moves the pistons up and down (not shown). This attachment fixture 201 may be of any suitable design to interface with various air displacement pipettors and this will not affect the novel operation of the embodiment.

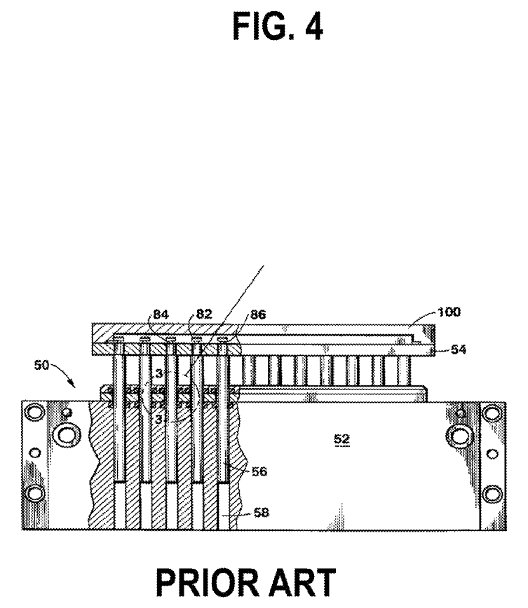

FIG. 2. provides a sectional view of the embodiment and more clearly illustrates the interior parts of the channels 102 and pistons 200. In this sectional view, one row of twelve channels 102 are visible in a cutaway view. In some aspects, both the channels 102 and the pistons 200 have a multistage cylindrical design as opposed to a straight cylindrical design. As an example, FIG. 4 shows a typical similar arrangement as used by the prior art. In this drawing, the cylindrical channels 58 and the pistons 56 are straight cylinders over the entirety of their length.

FIG. 2 illustrates how the embodiment is different than prior art by using a multistage or multisized channel/piston design. The channels 102 each include a lower narrow diameter cylinder 104 and an upper larger diameter cylinder 105. The pistons 200 have a corresponding multistage design with a narrow diameter piston 204 at the bottom part and a larger diameter piston 203 above the narrow diameter piston 204. The remaining upper part of the piston 202 connects to the attachment fixture 201 to provide the suitable attachment of the pistons to the driving mechanism.

The standard design of the air displacement pipetting piston arrangement requires that a reliable seal is provided at the top of the pipettor block 100 where the pistons 200 exit the cylindrical channels 102 and where they are attached to the driving mechanism. This seal, which is typically an o-ring, prevents the leakage of the external atmospheric pressure into the air space below the piston, which must maintain its partial vacuum or low pressure in order for the air displacement pipetting operations to perform optimally. A typical prior art arrangement is show in FIG. 4 where dual o-rings 3 are used to provide the seal between the pipettor block 52 and the piston 56. FIG. 2 illustrates one aspect of the embodiment which is the design and placement of a multistage o-ring sealing arrangement which can function for both a narrow piston for low volume pipetting and for a larger piston (wider than the narrow piston portion) for larger volume pipetting. When the pipettor is used for the lower volume range, the lower o-ring 301 provides the necessary seal between the piston’s 200 lower part 204 and the pipettor block 100. There is also an upper o-ring 302 which provides the necessary seal for the piston’s 200 upper part 203. In this example, the upper o-ring 302 and lower o-ring 301 have different sizes (e.g., different diameters).

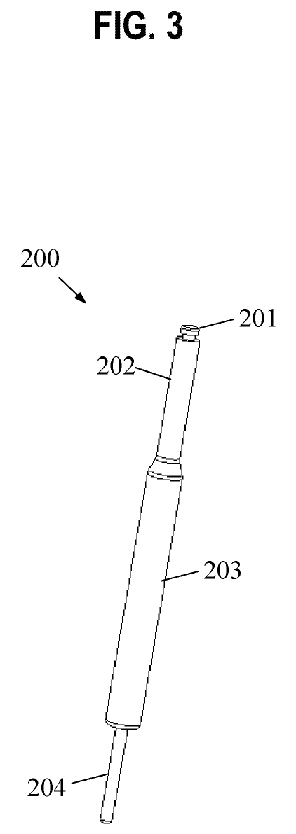

Another aspect of the embodiment is the design of the piston which allows the operation of both low volume and high volume air displacement pipetting while maintaining a proper and reliable seal between the piston 200 and the pipettor block 100. FIG. 3 shows the three important parts of the piston 200 which enable this low/high volume capability to work. These are the lower narrow piston section 204, the larger middle piston section 203, and the upper section 202 which is slightly narrower than the middle section 203. In this example, the piston 200 have three different diameters.

FIG. 2 illustrates how low and high pipetting volumes can be achieved with optimal piston diameters using a single piston/block arrangement. There are five exemplary pistons 200 shown at varying heights within the pipettor block 100 such as they might be moved by the connecting driver motor or force above which is connected to the attachment fixture 201. The leftmost piston A is shown in the lowermost position within the pipettor block 100, where it would be positioned at the start of a pipetting operation. Piston B is shown moved vertically a small distance, and piston C is slightly higher than piston B. In this vertical movement range, the lower o-rings 301 will provide the required seal to maintain a reliable partial vacuum as is required for air displacement pipetting. An aspect of the embodiment is that the design of the piston 200 is such that the upper o-ring 302 is not compressed against the piston body, as this is not needed since the lower o-ring 301 is providing the seal. This also prevents an undesired partial vacuum from forming in the air space above the lower narrow section 204 of the piston 200. The design of the embodiment is such that the pipettor can be programmed to operate the pistons 200 vertically only within the range of the lower diameter section 204 of the piston, and this smaller air displacement volume will the ideally suited for the best performance of accuracy and precision at the lower volumes. When the lower diameter section is in use for sealing the channel, the same vertical movement of the piston 200 provides finer volume control than when the larger dimeter section 203 is in use.

FIG. 2 similarly illustrates the positioning of the piston 200 for higher volume air displacement pipetting. In this case, the pistons 200 are moved further up such as shown by piston E. In this condition, the lower piston section 204 has been raised above the location of the lower o-ring 301 so it is no longer providing a seal or interfering with the partial vacuum air space. Now the upper larger diameter part of the piston 203 is in contact with the upper o-ring 302, providing the suitable seal and allowing for an air displacement pipetting function with the best performance for the higher volumes.

What is claimed is:

1. A pipetting apparatus comprising:
a pipettor block having at least one channel with a varying internal diameter along a longitudinal axis of the at least one channel;
a piston configured to move within the at least one channel and comprising at least two portions of different diameters; and
a sealing arrangement configured to form a seal with a selected portion of the piston based on a position of the piston in the at least one channel.

2. The pipetting apparatus of claim 1, wherein the sealing arrangement comprises at least two o-rings disposed at vertically separated positions along the channel with respective different diameters at the vertically separated positions.

3. The pipetting apparatus of claim 1, wherein the at least two portions of the piston comprise a first piston segment with a first diameter and a second piston segment with a second diameter that is larger than the first diameter.

4. The pipetting apparatus of claim 3, wherein the first piston segment is configured to form a first seal of the sealing arrangement, and the second piston segment is configured to form a second seal of the sealing arrangement, the first seal and the second seal corresponding to different internal diameters of the at least one channel.

5. The pipetting apparatus of claim 4, wherein the piston remains sealed against the at least one channel during operation using only one of the first seal and the second seal.

6. The pipetting apparatus of claim 1,
wherein the at least two portions of the piston comprise a first piston segment with a first diameter, a second piston segment with a second diameter, and a third piston segment between the first piston segment and the second piston segment, and
wherein the second piston segment has a diameter that is larger than the first diameter and smaller than the third diameter, and
wherein the second piston segment forms no seal with the at least one channel during operation of the pipetting apparatus.

7. The pipetting apparatus of claim 6, when the first piston segment is in use for sealing the at least one channel, the same vertical movement of the piston provides finer volume control than when the third piston segment is in use for sealing the at least one channel.

8. The pipetting apparatus of claim 1, wherein the at least one channel comprises a plurality of channels arranged in an array.

9. The pipetting apparatus of claim 1, wherein a movement of the piston within the at least one channel enables displacement of air to aspirate and dispense liquid volumes across a plurality of volume ranges comprising a first volume range corresponding to a first diameter of the at least one channel and a second volume range corresponding to a second diameter of the at least one channel.

10. A method for pipetting fluid, comprising:
inserting a piston into a channel comprising at least two regions with respective different internal diameters, the comprising a first piston region with a first piston diameter and a second piston region with a second piston diameter that is different from the first piston diameter;
selectively forming a seal between the first piston region or the second piston region with the channel based on a position of the piston in the channel; and
displacing a fluid using the piston to aspirate and dispense fluid by moving the piston to different regions of the channel.

11. The method of claim 10, wherein the selectively forming the seal comprises:
forming a first seal between the first piston region and a first region of the channel for a first volume range; and
forming a second seal between the second piston region and a second region of the channel for a second volume range.

12. The method of claim 10, wherein the selectively forming the seal comprises:
compressing a first o-ring between the first piston region and a first region of the channel for a first volume range; and
compressing a second o-ring between the second piston region and a second region of the channel for a second volume range.

13. A pipetting apparatus comprising:
means for defining a channel with a varying internal diameter along a longitudinal axis of the channel;
means for displacing air within the channel via a piston that comprises at least two portions of different diameters; and
means for sealing a selected portion of the at least two portions of the piston based on a sealing position in the channel.

14. The pipetting apparatus of claim 13, wherein the means for sealing comprises at least two sealing means positioned at distinct vertical locations of the channel.

15. The pipetting apparatus of claim 13, further comprising means for attaching disposable pipette tips to a lower end of the channel.
